(19) United States
(12) Patent Application Publication
(10) Pub. No.: US 2018/0244963 A1
(43) Pub. Date: Aug. 30, 2018

(54) ADHESIVE AGENT COMPOSITION AND ADHESIVE SHEET

(71) Applicant: LINTEC CORPORATION, Tokyo (JP)

(72) Inventors: Ken TAKANO, Tokyo (JP); Kazuhiro KIKUCHI, Tokyo (JP); Takashi SUGINO, Tokyo (JP)

(21) Appl. No.: 15/756,426

(22) PCT Filed: Sep. 1, 2016
(86) PCT No.: PCT/JP2016/075602

§ 371 Date: Feb. 28, 2018

(30) Foreign Application Priority Data
Sep. 1, 2015 (JP) 2015-172395

(51) Int. Cl. C09J 133/08; C09J 7/30; C09J 7/25

(52) U.S. Cl. CPC C09J 133/08; C09J 7/30; C09J 2467/006; C09J 2433/00; C09J 7/255

(57) ABSTRACT

An adhesive composition contains an acrylic copolymer and an adhesive aid, in which the acrylic copolymer contains 2-ethylhexyl acrylate as a main monomer, and the adhesive aid contains as a main component a rubber material having a reactive group. An adhesive sheet includes a base material and an adhesive layer containing the adhesive composition.

### TECHNICAL FIELD

The present invention relates to an adhesive composition and an adhesive sheet.

### BACKGROUND ART

An adhesive sheet used in a manufacturing process of a semiconductor device is required to have various characteristics. In recent years, the adhesive sheet is desired not to dirty a machine, a member and an adherend used in the manufacturing process even after the adhesive sheet is subjected to a step performed under a high temperature. Further, when the adhesive sheet is peeled at the room temperature after the step performed under a high temperature, it is desired that the adhesive sheet is less likely to leave an adhesive on the adherend and the like (so-called adhesive residue) and requires a small peeling force.

For instance, Patent Literature 1 discloses a masking sheet for reducing an adhesive residue and stably manufacturing a QFN (Quad Flat Non-lead) semiconductor package. Patent Literature 1 discloses that the masking sheet produced with a particular heat-resistant film and a particular silicone adhesive is resistant to conditions of a temperature ranging from 150 degrees C. to 180 degrees C. for one to six hours in a die attachment step and a resin seal step.

### CITATION LIST

### Patent Literature(s)

Patent Literature 1: JP2002-275435A

### SUMMARY OF THE INVENTION

### Problem(s) to be Solved by the Invention

However, since the heat-resistant film (e.g., a polyimide film) and the silicone adhesive used for manufacturing the masking sheet of Patent Literature 1 are expensive, use of the masking sheet is limited to a particular use such as the QFN package and the like. When the silicone adhesive is used, a low-molecular-weight siloxane may be left on a surface of the adherend after the masking sheet is peeled off, so that an electric contact failure may be caused. Further, the residue of the silicone adhesive is water-repellent and oil-repellent. Accordingly, a property of an electric connector to be capable of being plated may be deteriorated and an adhesive force of a protective material of a circuit surface may be decreased, which may increase electric resistance and generate cracks to deteriorate package reliability (e.g., cause a failure) Moreover, various studies have been made on the adhesive leaving less residue. In some adhesives, an adhesive force becomes excessively large after being subjected to a step performed under a high temperature, which may make it difficult to peel the adhesive sheet.

An object of the invention is to provide an adhesive composition easily peelable from an adherend and leaving less adhesive residue even after being subjected to a step performed under a high temperature, and an adhesive sheet using the adhesive composition.

### Means for Solving the Problem(s)

According to an aspect of the invention, an adhesive composition contains an acrylic copolymer and an adhesive aid, in which the acrylic copolymer contains 2-ethylhexyl acrylate as a main monomer, and the adhesive aid contains a rubber material having a reactive group, as a main component.

In the adhesive composition of the above arrangement, the reactive group is preferably a hydroxyl group.

In the adhesive composition of the above arrangement, the rubber material is preferably a polybutadiene material.

In the adhesive composition of the above arrangement, the rubber material is preferably a hydrogenated polybutadiene material.

In the adhesive composition of the above arrangement, the adhesive composition preferably contains a cross-linked substance obtained by cross-linking a composition at least containing the acrylic copolymer, the adhesive aid, and a cross-linker containing a compound having an isocyanate group as a main component.

In the adhesive composition of the above arrangement, a ratio of a copolymer derived from 2-ethylhexyl acrylate to the acrylic copolymer is preferably in a range from 50 mass % to 95 mass %.

In the adhesive composition of the above arrangement, it is preferable that the acrylic copolymer further contains a copolymer component derived from an acrylic acid, and a ratio of the copolymer component derived from the acrylic acid in the acrylic copolymer is 1 mass % or less.

According to another aspect of the invention, an adhesive sheet includes: a base material; and an adhesive layer containing the above-described adhesive composition.

In the adhesive sheet of the above arrangement, the adhesive layer preferably has an adhesive force to a copper foil and a polyimide film in a range from 0.7 N/25 mm to 2.0 N/25 mm at a room temperature, after the adhesive sheet is heated at 100 degrees C. for 30 minutes, subsequently at 180 degrees C. for 30 minutes, and further at 190 degrees C. for one hour.

In the adhesive sheet of the above arrangement, the adhesive sheet has a thickness in a range from 5 μm to 60 μm.

According to the above aspects of the invention, an adhesive composition easily peelable from an adherend and leaving less adhesive residue even after being subjected to a step performed under a high temperature, and an adhesive sheet using the adhesive composition can be provided.

### BRIEF DESCRIPTION OF DRAWING(S)

FIG. 1 is a schematic cross-sectional view of an adhesive sheet according to a first exemplary embodiment of the invention.

FIG. 2A illustrates a part of a manufacturing process of a semiconductor device using the adhesive sheet according to the first exemplary embodiment.

FIG. 2B illustrates another part of a manufacturing process of the semiconductor device using the adhesive sheet according to the first exemplary embodiment.

FIG. 2C illustrates still another part of a manufacturing process of the semiconductor device using the adhesive sheet according to the first exemplary embodiment.

FIG. 2D illustrates a further part of a manufacturing process of the semiconductor device using the adhesive sheet according to the first exemplary embodiment.

FIG. 2E illustrates a still further part of a manufacturing process of the semiconductor device using the adhesive sheet according to the first exemplary embodiment.

### DESCRIPTION OF EMBODIMENT(S)

### First Exemplary Embodiment

### Adhesive Composition

An adhesive composition of a first exemplary embodiment contains an acrylic copolymer and an adhesive aid. The acrylic copolymer is a copolymer containing 2-ethylhexyl acrylate as a main monomer. The adhesive aid contains as a main component a rubber material having a reactive group (hereinafter also referred to as a reactive group-containing rubber material).

Herein, containing 2-ethylhexyl acrylate as the main monomer means that a ratio by mass of a copolymer component derived from 2-ethylhexyl acrylate to a total mass of the acrylic copolymer is 50 mass % or more. In the first exemplary embodiment, the ratio of the copolymer component derived from 2-ethylhexyl acrylate in the acrylic copolymer is preferably in a range from 50 mass % to 95 mass %, more preferably in a range from 60 mass % to 95 mass %, further preferably in a range from 80 mass % to 95 mass %, still further preferably in a range from 85 mass % to 93 mass %. When the ratio of the copolymer component derived from 2-ethylhexyl acrylate is 50 mass % or more, an adhesive force of an adhesive sheet is not excessively increased after the adhesive sheet is heated and the adhesive sheet is easily peelable from an adherend. At 80 mass % or more of the copolymer component, the adhesive sheet is more easily peelable from the adherend. When the copolymer component derived from 2-ethylhexyl acrylate is 95 mass % or less, a base material of the adhesive sheet can be prevented from being deformed during being heated due to an insufficient initial adhesive force, and the adhesive sheet can be prevented from being peeled off from the adherend due to the deformation of the base material.

A kind and the number of a copolymer component other than 2-ethylhexyl acrylate in the acrylic copolymer is not particularly limited. For instance, a second copolymer component is preferably a functional-group-containing monomer having a reactive functional group. When a later-described cross-linker is used, the reactive functional group of the second copolymer component is preferably a functional group capable of reacting with the cross-linker. The reactive functional group is preferably at least one substituent selected from the group consisting of a carboxyl group, a hydroxyl group, an amino group, a substituted amino group, and an epoxy group, more preferably at least one substituent of a carboxyl group or a hydroxyl group, further preferably a carboxyl group.

Examples of the monomer having a carboxyl group (i.e., carboxyl-group-containing monomer) include an ethylene unsaturated carboxylic acid such as an acrylic acid, methacrylic acid, crotonic acid, maleic acid, itaconic acid, and citraconic acid. Among the above examples of the carboxyl-group-containing monomer, an acrylic acid is preferable since the acrylic acid is easily reactive and copolymerizable. One of the examples of the carboxyl-group-containing monomer may be used alone or two or more thereof may be used in combination.

Examples of the monomer having a hydroxyl group (i.e., a hydroxyl-group-containing monomer) includes hydroxyalkylester (meth)acrylate such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Among the above examples of the hydroxyl-group-containing monomer, 2-hydroxyethyl (meth)acrylate is preferable since the hydroxyl group is easily reactive and copolymerizable. One of the examples of the hydroxyl-group-containing monomer may be used alone or two or more thereof may be used in combination. It should be noted that “(meth)acrylate” refers to both “acrylate” and “methacrylate” and the same applies to the other similar terms.

Examples of the acrylic acid ester having an epoxy group include glycidyl acrylate and glycidyl methacrylate.

The other copolymer component in the acrylic copolymer is exemplified by alkylester (meth)acrylate in which an alkyl group has 2 to 20 carbon atoms. Examples of alkylester (meth)acrylate include ethyl (meth)acrylate, propyl (meth)acrylate, n-butyl (meth)acrylate, n-pentyl (meth)acrylate, n-hexyl (meth)acrylate, 2-ethylhexyl methacrylate, isooctyl (meth)acrylate, n-decyl (meth)acrylate, n-dodecyl (meth)acrylate, myristyl (meth)acrylate, palmityl (meth)acrylate, and stearyl (meth)acrylate. Among the above examples of the alkylester (meth)acrylate, (meth)acrylate ester in which an alkyl group has 2 to 4 carbon atoms is preferable, n-butyl (meth)acrylate is more preferable in order to improve the adhesiveness. One of the examples of the alkylester (meth)acrylate may be used alone or two or more thereof may be used in combination.

The other copolymer component in the acrylic copolymer is also exemplified by a copolymer component derived from at least one monomer selected from the group consisting of alkoxyalkyl-group-containing (meth)acrylate ester, (meth)acrylate ester having an aliphatic ring, (meth)acrylate ester having an aromatic ring, non-cross-linking acrylamide, (meth)acrylate ester having a non-cross-linking tertiary amino group, vinyl acetate and styrene.

Examples of the alkoxyalkyl-group-containing (meth)acrylate ester include methoxymethyl (meth)acrylate, methoxyethyl (meth)acrylate, ethoxymethyl (meth)acrylate, and ethoxyethyl (meth)acrylate.

The (meth)acrylate ester having an aliphatic ring is exemplified by cyclohexyl (meth)acrylate.

The (meth)acrylate ester having an aromatic ring is exemplified by phenyl (meth)acrylate.

Examples of the non-cross-linking acrylamide include acrylamide and methacrylamide.

Examples of the (meth)acrylate ester having a non-cross-linking tertiary amino group include (N,N-dimethylamino) ethyl (meth)acrylate and (N,N-dimethylamino) propyl (meth)acrylate.

One of the examples of the monomer may be used alone or two or more thereof may be used in combination.

In the first exemplary embodiment, the second copolymer component is preferably the carboxyl-group-containing monomer or the hydroxyl-group-containing monomer, more preferably acrylic acid. When the acrylic copolymer contains the copolymer component derived from 2-ethylhexyl acrylate and the copolymer component derived from acrylic acid, a ratio by mass of the copolymer component derived from acrylic acid in a total mass of the acrylic copolymer is preferably 1 mass % or less, more preferably in a range from 0.1 mass % to 0.5 mass %. When the ratio of the copolymer component derived from acrylic acid is 1 mass % or less, a cross linking of the acrylic copolymer can be prevented from proceeding excessively fast with a cross-linker that may be contained in the adhesive composition.

The acrylic copolymer may contain copolymer components derived from two or more kinds of functional-group-containing monomers. For instance, the acrylic copolymer may be a terpolymer. When the acrylic copolymer is a terpolymer, the acrylic copolymer is preferably obtained by a copolymerization of 2-ethylhexyl acrylate, the carboxyl-group-containing monomer and the hydroxyl-group-containing monomer, in which the carboxyl-group-containing monomer is preferably acrylic acid and the hydroxyl-group-containing monomer is preferably 2-hydroxyethyl acrylate. It is preferable that the ratio of the copolymer component derived from 2-ethylhexyl acrylate in the acrylic copolymer is in a range from 80 mass % to 95 mass %, the ratio by mass of the copolymer component derived from acrylic acid in the acrylic copolymer is 1 mass % or less, and the rest of the acrylic copolymer is the copolymer component derived from 2-hydroxyethyl acrylate.

A weight average molecular weight (Mw) of the acrylic copolymer is preferably in a range from 300,000 to 2,000,000, more preferably from 600,000 to 1,500,000, further preferably from 800,000 to 1,200,000. At 300,000 or more of the weight average molecular weight Mw of the acrylic copolymer, the adhesive sheet can be peeled off from the adherend without leaving any residue of the adhesive on the adherend. At 2,000,000 or less of the weight average molecular weight Mw of the acrylic copolymer, the adhesive sheet can be firmly stuck on the adherend.

The weight average molecular weight Mw of the acrylic copolymer is a standard polystyrene conversion value measured according to a Gel Permeation Chromatography (GPC) method.

The acrylic copolymer can be prepared using the above-mentioned various monomers (source material) according to a publicly known method.

A copolymerization form of the acrylic copolymer is not particularly limited. The acrylic copolymer may be a block copolymer, a random copolymer or a graft copolymer.

In the exemplary embodiment, a content ratio of the acrylic copolymer contained in the adhesive composition is preferably in a range from 40 mass % to 90 mass %, more preferably from 50 mass % to 90 mass %.

The adhesive aid in the exemplary embodiment contains a reactive group-containing rubber material as a main component. When the adhesive composition contains the reactive adhesive aid, an adhesive residue can be reduced. A content ratio of the adhesive aid in the adhesive composition is preferably in a range from 3 mass % to 50 mass %, more preferably from 5 mass % to 30 mass %. At 3 mass % or more of the adhesive aid in the adhesive composition, generation of the adhesive residue is reducible. At 50 mass % or less of the adhesive aid in the adhesive composition, decrease in the adhesive force is avoidable.

Herein, containing the reactive group-containing rubber material as the main monomer means that a ratio by mass of the reactive group-containing rubber material to a total mass of the adhesive aid exceeds 50 mass %. In the exemplary embodiment, the ratio of the reactive group-containing rubber material in the adhesive aid is preferably more than 50 mass %, more preferably 80 mass % or more. It is also preferable that the adhesive aid is substantially formed of the reactive group-containing rubber material.

The reactive group is preferably at least one functional group selected from the group consisting of a hydroxyl group, isocyanate group, amino group, oxirane group, acid anhydride group, alkoxy group, acryloyl group and methacryloyl group, more preferably a hydroxyl group. The rubber material may contain one or more reactive groups. The rubber material having the hydroxyl group may further have the above-described reactive group. The number of the reactive group contained in one molecule of the rubber material may be one or more.

The rubber material, which is not particularly limited, is preferably a polybutadiene material. The polybutadiene material is preferably a polybutadiene resin and a hydrogenated substance of a polybutadiene resin, more preferably a hydrogenated substance of a polybutadiene resin.

Examples of the polybutadiene resin include a polybutadiene resin having 1,4-repeating units, a polybutadiene resin having 1,2-repeating units, and a polybutadiene resin having both 1,4-repeating units and 1,2-repeating units. In the exemplary embodiment, the hydrogenated substance of the polybutadiene resin also includes hydrides of the polybutadiene resin having 1,4-repeating units, the polybutadiene resin having 1,2-repeating units, and the polybutadiene resin having both 1,4-repeating units and 1,2-repeating units.

Each of the polybutadiene resin and the hydrogenated substance of the polybutadiene resin preferably have the reactive groups at both ends. The reactive groups at both the ends may be the same or different. The reactive group at each of the ends is preferably at least one functional group selected from the group consisting of a hydroxyl group, isocyanate group, amino group, oxirane group, acid anhydride group, alkoxy group, acryloyl group and methacryloyl group, more preferably a hydroxyl group. Each of the polybutadiene resin and the hydrogenated substance of the polybutadiene resin more preferably have a hydroxyl group at each of ends.

It is also preferable that the adhesive composition in the exemplary embodiment contains a cross-linked substance obtained by cross-linking a composition at least containing the acrylic copolymer, the adhesive aid, and a cross-linker. Moreover, it is also preferable that a solid content of the adhesive composition substantially consists of a cross-linked substance obtained by cross-linking the acrylic copolymer, the adhesive aid and the cross-linker as described above. Herein, the term “substantially” means that the solid content of the adhesive composition is only formed of the cross-linked substance except for a minute amount of impurities unavoidably mixed in the adhesive.

In the exemplary embodiment, examples of the cross linker include an isocyanate cross-linker, epoxy cross-linker, aziridine cross-linker, metal chelate cross-linker, amine cross-linker, and an amino resin cross-linker. One of the examples of the cross-linker may be used alone or two or more thereof may be used in combination.

In the exemplary embodiment, in order to improve heat resistance and an adhesive force of the adhesive composition, a cross-linker (isocyanate cross-linker) containing as a main component a compound having an isocyanate group is preferable among the examples of the above cross-linker. Examples of the isocyanate cross-linker include a polyvalent isocyanate compound such as 2,4-tolylene diisocyanate, 2,6-tolylene diisocyanate, 1,3-xylylene diisocyanate, 1,4-xylylene diisocyanate, diphenylmethane-4,4′-diisocyanate, diphenylmethane-2,4′-diisocyanate, 3-methyldiphenyl methane diisocyanate, hexamethylene diisocyanate, isophorone diisocyanate, dicyclohexylmethane-4,4′-diisocyanate, dicyclohexylmethane-2,4′-diisocyanate, and lysine isocyanate.

Moreover, the polyvalent isocyanate compound may be in a form of trimethylolpropane-adduct modified substances of the above-exemplified compounds, Biuret modified substances obtained by reacting the above-exemplified compounds with water, or isocyanurate modified substances having an isocyanurate ring of the above-exemplified compounds having.

Herein, the cross-linker containing the compound having the isocyanate group as the main component means that a ratio by mass of the compound having the isocyanate group in a total mass of components of the cross-linker is 50 mass % or more.

In the exemplary embodiment, a content of the cross-linker in the adhesive composition is preferably in a range from 0.1 parts by mass to 20 parts by mass, more preferably from 1 part by mass to 15 parts by mass, further preferably from 5 parts by mass to 10 parts by mass based on 100 parts by mass of the acrylic copolymer. When the content of the cross-linker in the adhesive composition falls within the above range, adhesiveness between a layer containing the adhesive composition (adhesive layer) and the adherend (e.g., base material) can be improved, thereby shortening a curing period for stabilizing adhesiveness of the produced adhesive sheet.

In the exemplary embodiment, in view of the heat resistance of the adhesive composition, the isocyanate cross-linker is further preferably a compound having an isocyanurate ring (isocyanurate modified substance). The compound having the isocyanurate ring is preferably contained in a range from 0.7 equivalent to 1.5 equivalent relative to a hydroxyl group equivalent of the acrylic copolymer. When the content of the compound having the isocyanurate ring is 0.7 equivalent or more, an adhesive force of the adhesive sheet is not excessively increased after the adhesive sheet is heated, so that the adhesive sheet is easily peelable and an adhesive residue is reducible. When the content of the compound having the isocyanurate ring is 1.5 equivalent or less, an initial adhesive force of the adhesive sheet can be prevented from excessively decreasing and stickability of the adhesive sheet can be prevented from decreasing.

When the adhesive composition contains the cross-linker in the exemplary embodiment, it is preferable that the adhesive composition further contains a cross-linking accelerator. It is preferable that the cross-linking accelerator is selectively used as needed depending on a kind and the like of the cross-linker. For instance, when the adhesive composition contains a polyisocyanate compound as the cross-linker, it is preferable that the adhesive composition further contains a cross-linking accelerator derived from an organic metal compound such as an organic tin compound.

In the exemplary embodiment, the adhesive composition may contain additional component(s) as long as the effect(s) of the invention is not impaired. Examples of the additional component(s) containable in the adhesive composition include an organic solvent, flame retardant, tackifier, ultraviolet absorber, antioxidant, preservative, antifungal agent, plasticizer, antifoaming agent and wettability modifier.

The adhesive composition of the exemplary embodiment is specifically exemplified by the following examples of the adhesive composition. However, the invention is by no means limited to the examples.

As one example, the adhesive composition in the exemplary embodiment contains the acrylic copolymer, the adhesive aid, and the cross-linker, in which the acrylic copolymer is obtained by copolymerizing at least 2-ethylhexyl acrylate, the carboxyl-group-containing monomer and the hydroxyl-group-containing monomer, the adhesive aid contains the reactive group-containing rubber material as the main component, and the cross-linker is the isocyanate cross-linker.

As another example, the adhesive composition in the exemplary embodiment contains the acrylic copolymer, the adhesive aid, and the cross-linker, in which the acrylic copolymer is obtained by copolymerizing at least 2-ethylhexyl acrylate, the carboxyl-group-containing monomer and the hydroxyl-group-containing monomer, the adhesive aid is hydrogenated polybutadiene having hydroxyl groups at both ends, and the cross-linker is the isocyanate cross-linker.

As still another example, the adhesive composition in the exemplary embodiment contains the acrylic copolymer, the adhesive aid, and the cross-linker, in which the acrylic copolymer is obtained by copolymerizing at least 2-ethylhexyl acrylate, acrylate and 2-hydroxyethyl acrylate, the adhesive aid contains the reactive group-containing rubber material as the main component, and the cross-linker is the isocyanate cross-linker.

As a further example, the adhesive composition in the exemplary embodiment contains the acrylic copolymer, the adhesive aid, and cross-linker, in which the acrylic copolymer is obtained by copolymerizing at least 2-ethylhexyl acrylate, acrylate and 2-hydroxyethyl acrylate, the adhesive aid is hydrogenated polybutadiene having hydroxyl groups at both ends, and the cross-linker is the isocyanate cross-linker.

In the above examples of the adhesive composition of the exemplary embodiment, it is preferable that the ratio of the copolymer component derived from 2-ethylhexyl acrylate is in a range from 80 mass % to 95 mass %, the ratio by mass of the copolymer component derived from the carboxyl-group-containing monomer is 1 mass % or less, and the rest of the acrylic copolymer is a copolymer component other than the above copolymer components. The other copolymer component is preferably a copolymer component derived from the hydroxyl-group-containing monomer.

### Adhesive Sheet

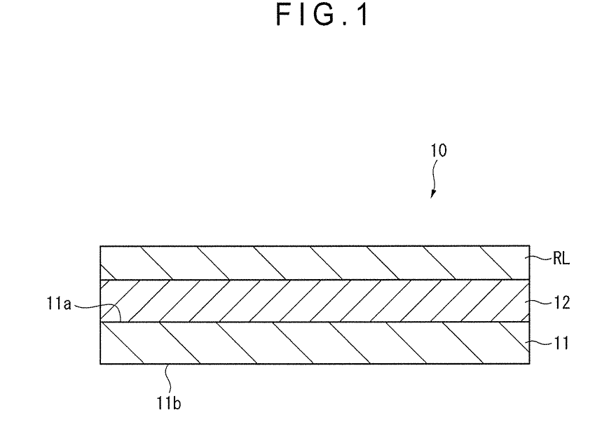

FIG. 1 is a schematic cross-sectional view of an adhesive sheet 10 of the exemplary embodiment.

The adhesive sheet 10 includes a base material 11 and an adhesive layer 12. A release sheet RL is layered on the adhesive layer 12 as shown in FIG. 1. The adhesive sheet 10 can be in various forms such as a sheet, a tape, and a label.

The adhesive sheet of the exemplary embodiment is preferably used in a process including: attaching a frame having a plurality of openings to the adhesive sheet including the base material and the adhesive layer; attaching a semiconductor chip to the adhesive layer exposed from the openings of the frame; covering the semiconductor chip with a sealing resin; and thermally curing the sealing resin.

The adhesive layer 12 contains the above-described adhesive composition of the exemplary embodiment.

A thickness of the adhesive layer 12 is appropriately determined depending on the intended use of the adhesive sheet 10. In the exemplary embodiment, the thickness of the adhesive layer 12 is preferably in a range from 5 μm to 60 μm, more preferably from 10 μm to 50 μm. When the thickness of the adhesive layer 12 is excessively small, the adhesive layer 12 cannot conform to an uneven circuit surface of the semiconductor chip, which may generate a gap between the adhesive layer 12 and the circuit surface. For instance, an interlayer insulative material, a sealing resin and the like may enter the gap to cover an electrode pad for connecting wires on the circuit surface of the semiconductor chip. When the thickness of the adhesive layer 12 is 5 μm or more, the adhesive layer 12 can easily conform to the uneven circuit surface of the semiconductor chip, which can prevent generation of a gap between the adhesive layer 12 and the circuit surface. When the thickness of the adhesive layer 12 is excessively large, the semiconductor chip may be sunk in the adhesive layer to generate a level difference between the semiconductor chip and the resin sealing the semiconductor chip. If such a level difference is generated, the wires may be broken at rewiring. When the thickness of the adhesive layer 12 is 60 μm or less, the level difference is unlikely to be generated.

### Base Material

The base material 11 is a member supporting the adhesive layer 12.

The base material 11 has a first surface 11a and a second surface 11b opposite to the first surface 11a. In the adhesive sheet 10 of the exemplary embodiment, the adhesive layer 12 is layered on the first surface 11a. In order to enhance cohesion between the base material 11 and the adhesive layer 12, the first surface 11a may be subjected to at least one surface treatment of a primer treatment, corona treatment, plasma treatment and the like. The first surface 11a of the base material 11 also may be subjected to an adhesive treatment in which an adhesive is applied on the first surface 11a. Examples of the adhesive used for the adhesive treatment of the base material include an acrylic adhesive, rubber adhesive, silicone adhesive and urethane adhesive.

A thickness of the base material 11 is preferably in a range from 10 μm to 500 μm, more preferably from 15 μm to 300 μm, further preferably from 20 μm to 250 μm.

As the base material 11, for instance, a sheet material such as a synthetic resin film is usable. Examples of the synthetic resin film include a polyethylene film, polypropylene film, polybutene film, polybutadiene film, polymethylpentene film, polyvinyl chloride film, polyvinyl chloride copolymer film, polyethylene terephthalate film, polyethylene naphthalate film, polybutylene terephthalate film, polyurethane film, ethylene vinyl acetate copolymer film, ionomer resin film, ethylene-(meth)acrylic acid copolymer film, ethylene-(meth)acrylic acid ester copolymer film, polystyrene film, polycarbonate film, and polyimide film. In addition, the base material 11 is exemplified by a cross-linking film, a laminate film and the like of the above synthetic resin films.

The base material 11 preferably contains a polyester resin. The base material 11 is more preferably formed of a material containing a polyester resin as a main component. Herein, the material containing the polyester resin as the main component means that a ratio by mass of the polyester resin in a total mass of materials for the base material is 50 mass % or more. The polyester resin is preferably a resin selected from the group consisting of a polyethylene terephthalate resin, polybutylene terephthalate resin, polyethylene naphthalate resin, polybutylene naphthalate resin, and a copolymer resin of the above resins, more preferably a polyethylene terephthalate resin.

The base material 11 is preferably a polyethylene terephthalate film or a polyethylene naphthalate film, more preferably a polyethylene terephthalate film. An oligomer contained in a polyester film is derived from a polyester-formable monomer, dimer, trimer and the like.

### Release Sheet

A structure of a release sheet RL is not particularly limited. For instance, in terms of easy handling, the release sheet RL preferably includes a release base material and at least one release agent layer provided by applying a release agent on the release base material. The release sheet RL may include the release agent layer applied on one surface of the release base material or may include the release agent layers applied on both surfaces of the release base material. Examples of the release base material include a paper base material, a laminate paper provided by laminating a thermoplastic resin (e.g., polyethylene) on the paper base material, and a plastic film. Examples of the paper base material include a glassine paper, coated paper and cast coated paper. Examples of the plastic film include: polyester films such as polyethylene terephthalate, polybutylene terephthalate and polyethylene naphthalate; and polyolefin films such as polypropylene and polyethylene. Examples of the release agent include an olefin rein, rubber elastomer (e.g., butadiene resin and isoprene resin), long-chain alkyl resin, alkyd resin, fluorine resin and silicone resin.

A thickness of the release sheet RL is not particularly limited. The thickness of the release sheet RL is usually in a range from 20 μm to 200 μm and is preferably in a range from 25 μm to 150 μm.

A thickness of the release agent layer is not particularly limited. When the release agent layer is provided by applying a solution containing the release agent on the release base material, the thickness of the release agent layer is preferably in a range from 0.01 μm to 2.0 μm, more preferably in a range from 0.03 μm to 1.0 μm.

When the plastic film is used as the release base material, a thickness of the plastic film is preferably in a range from 3 μm to 50 μm, more preferably in a range from 5 μm to 40 μm.

The adhesive sheet 10 of the exemplary embodiment preferably exhibits an adhesive force as indicated below after the adhesive sheet 10 is heated. Firstly, the adhesive sheet 10 is attached to an adherend (a copper foil or a polyimide film). The adhesive sheet 10 is heated at 100 degrees C. for 30 minutes, subsequently at 180 degrees C. for 30 minutes, and further at 190 degrees C. for one hour. After the heating, the adhesive layer 12 preferably has an adhesive force in a range from 0.7 N/25 mm to 2.0 N/25 mm at the room temperature against the copper foil or the polyimide film. When the adhesive force of the adhesive layer 12 after the heating is 0.7 N/25 mm or more, even if the base material or the adherend is deformed due to the heating, the adhesive sheet 10 can be prevented from being released from the adherend. When the adhesive force of the adhesive layer 12 after the heating is 2.0 N/25 mm or less, an excessively high peeling force is not required, in other words, the adhesive sheet 10 is easily released from the adherend.

Herein, the room temperature refers to a temperature ranging from 22 degrees C. to 24 degrees C. Herein, the adhesive force is represented by a measurement value obtained at a peeling speed (pulling speed) of 300 mm/minute at a 25-mm width of the adhesive sheet in accordance with a 180° tape peel method.

### Manufacturing Method of Adhesive Sheet

A manufacturing method of the adhesive sheet 10 is not particularly limited.

For instance, the adhesive sheet 10 may be produced through the following process. The adhesive composition is first applied on the first surface 11a of the base material 11 to form a coating film. The coating film is then dried to form the adhesive layer 12. Subsequently, the release sheet RL is attached to cover the adhesive layer 12.

Alternatively, the adhesive sheet 10 may be produced through the following process. The adhesive composition is first applied on the release sheet RL to form a coating film. The coating film is then dried to form the adhesive layer 12. The first surface 11a of the base material 11 is attached to the adhesive layer 12.

When the adhesive layer 12 is formed by application of the adhesive composition, the adhesive composition is preferably diluted with an organic solvent to prepare a coating solution for use. Examples of the organic solvent include toluene, ethyl acetate, and methyl ethyl ketone. An application method of the coating solution is not particularly limited. Examples of the application method include spin coating, spray coating, bar coating, knife coating, roll knife coating, roll coating, blade coating, die coating and gravure coating.

In order to prevent the organic solvent and a low-boiling-point component from remaining on the adhesive layer 12, it is preferable that, after the coating solution is applied on the base material 11 or the release sheet RL to form the coating film, the coating film is heated to be dried. Moreover, when the adhesive composition contains the cross-linker, the coating film is preferably heated also in order to promote a cross-linking reaction to improve a cohesion force.

### Use of Adhesive Sheet

The adhesive sheet 10 is used for sealing a semiconductor element. The adhesive sheet 10 is preferably used for sealing a semiconductor element that is not installed on a metallic lead frame but attached on the adhesive sheet 10. Specifically, it is preferable that the adhesive sheet 10 is not used for sealing a semiconductor element installed on a metallic lead frame but is used for sealing a semiconductor element attached on the adhesive layer 12. Examples of packaging of the semiconductor element without using the metallic lead frame include Panel Scale Package (PSP) and Wafer Level Package (WLP).

The adhesive sheet 10 is preferably used in a process including: attaching a frame having a plurality of openings to the adhesive sheet 10; attaching a semiconductor chip to the adhesive layer 12 exposed from the openings of the frame; covering the semiconductor chip with a sealing resin; and thermally curing the sealing resin.

### Manufacturing Method of Semiconductor Device

A manufacturing method of a semiconductor device using the adhesive sheet 10 of the exemplary embodiment will be described.

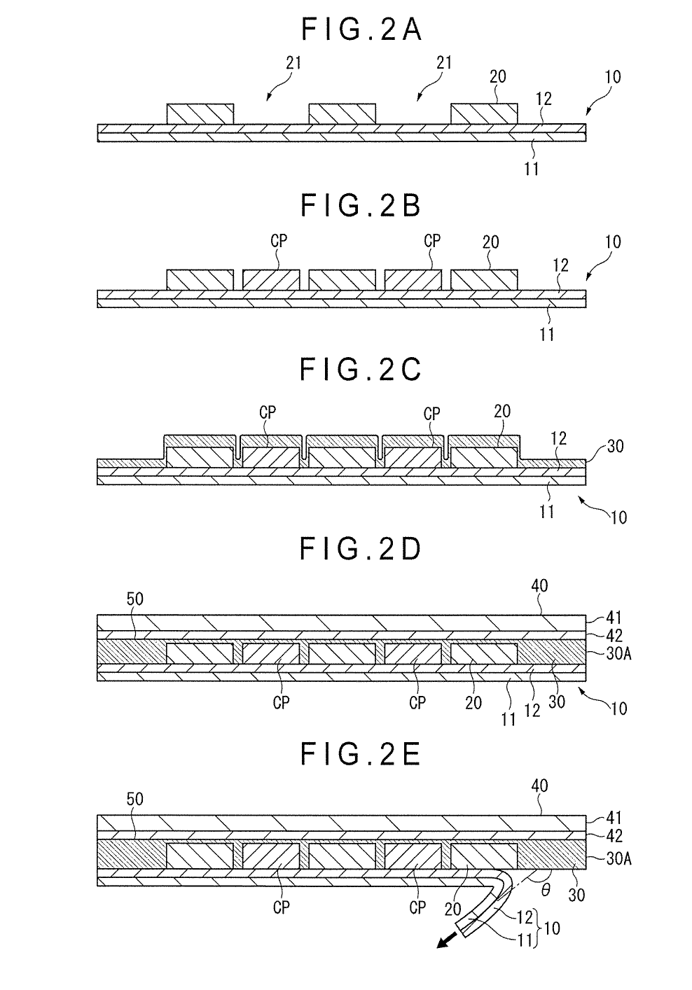

FIGS. 2A to 2E show schematic illustrations for describing the manufacturing method of the semiconductor device of the exemplary embodiment.

The manufacturing method of the semiconductor device of the exemplary embodiment includes: attaching a frame 20 having a plurality of openings 21 to the adhesive sheet 10 (adhesive-sheet-attaching step); attaching a semiconductor chip CP to the adhesive layer 12 exposed from the openings 21 of the frame 20 (bonding step); covering the semiconductor chip CP with a sealing resin 30 (sealing step); thermally curing the sealing resin 30 (thermal cure step); and peeling the adhesive sheet 10 (peeling step). After the thermal cure step, attaching a reinforcing member 40 to a sealing member 50 sealed with the sealing resin 30 (reinforcing-member-attaching step) may be performed as needed. Each of the steps will be described below.

### Adhesive-Sheet-Attaching Step

FIG. 2A is a schematic illustration for describing the step of attaching the frame 20 to the adhesive layer 12 of the adhesive sheet 10. It should be noted that the release sheet RL is peeled in advance from the adhesive sheet 10 when the adhesive sheet 10 is attached with the release sheet RL.

The frame 20 of the exemplary embodiment, which is in a form of a lattice, has a plurality of openings 21. The frame 20 is preferably formed of a heat-resistant material. Examples of the material for the frame 20 include: metal such as copper and stainless steel; and heat resistant resins such as a polyimide resin and a glass epoxy resin.

The openings 21 are holes penetrating the frame 20 from a front surface to a rear surface of the frame 20. The openings 21 may have any shape capable of housing the semiconductor chips CP therein. The openings 21 also may have any hole depth capable of housing the semiconductor chips CP therein.

### Bonding Step

FIG. 2B is a schematic illustration for describing the step of attaching the semiconductor chips CP to the adhesive layer 12.

After the adhesive sheet 10 is attached to the frame 20, the adhesive layer 12 is exposed from the openings 21 in a manner to correspond to the shape of each of the openings 21. The semiconductor chip CP is attached to the adhesive layer 12 exposed from each of the openings 21. The semiconductor chip CP is attached to the adhesive layer 12 such that a circuit surface of the semiconductor chip CP covers the adhesive layer 12.

The semiconductor chip CP is manufactured by performing a back grinding step of grinding a rear surface of the semiconductor wafer formed with a circuit, and a dicing step of cutting the semiconductor wafer into pieces. In the dicing step, the semiconductor wafer is attached to an adhesive layer of a dicing sheet and cut into pieces with a cutter (e.g., a dicing saw) to provide semiconductor chips CP (semiconductor elements).

A dicing machine is not particularly limited. Any known dicing machines are usable. Conditions of dicing are not particularly limited. It should be noted that, in place of the dicing method using a dicing blade, a laser dicing method or a stealth dicing method may be used.

After the dicing step, an expanding step of increasing an interval between a plurality of the semiconductor chips CP by expanding the dicing sheet may be performed. By performing the expanding step, the semiconductor chips CP can be picked up using a carrier such as a collet. Moreover, by performing the expanding step, an adhesive force of the adhesive layer of the dicing sheet is decreased, so that the semiconductor chips CP can be easily picked up.

When an energy-beam polymerizable compound is contained in an adhesive composition or the adhesive layer of the dicing sheet, the adhesive layer is irradiated with an energy beam from a direction of the base material of the dicing sheet to cure the energy-beam polymerizable compound. Curing of the energy-beam polymerizable compound enhances the cohesion force of the adhesive layer, so that the adhesive force of the adhesive layer is reducible. The energy beam is exemplified by an ultraviolet ray (UV) and an electron beam (EB), among which an ultraviolet ray is preferable. The irradiation of the energy beam may be performed either after the semiconductor wafer is attached or before the semiconductor chips are picked up. For instance, the irradiation of the energy beam may be performed before or after the dicing, or alternatively, the irradiation of the energy beam may be performed after the expanding step.

### Sealing Step and Thermal Cure Step

FIG. 2C is a schematic illustration for describing the step of sealing the semiconductor chips CP and the frame 20 which are attached to the adhesive sheet 10.

A material of the sealing resin 30 is a thermosetting resin (e.g., an epoxy resin). An epoxy resin used as the sealing resin 30 may contain, for instance, a phenol resin, elastomer, inorganic filler, and a curing accelerator.

A method of covering the semiconductor chips CP and the frame 20 with the sealing resin 30 is not particularly limited.

In the exemplary embodiment, the sealing resin 30 in a form of a sheet is used. The sheet-shaped sealing resin 30 is placed over the semiconductor chips CP and the frame 20. The sealing resin 30 is heated and cured to form a sealing resin layer 30A. The semiconductor chips CP and the frame 20 are thus embedded in the sealing resin layer 30A. When the sheet-shaped sealing resin 30 is used, the sealing resin 30 preferably seals the semiconductor chips CP and the frame 20 according to vacuum laminating method. The vacuum laminating method prevents generation of a gap between the semiconductor chips CP and the frame 20. A heating temperature in the vacuum laminating method ranges, for instance, from 80 degrees C. to 120 degrees C.

In the sealing step, a laminate sheet, in which the sheet-shaped sealing resin 30 is supported by a resin sheet such as polyethylene terephthalate sheet, may be used. In this case, after the sealing resin 30 is placed over the semiconductor chips CP and the frame 20, the resin sheet may be peeled off from the sealing resin 30 and the sealing resin 30 may be heated and cured. The laminate sheet is exemplified by ABF film (manufactured by Ajinomoto Fine-Techno Co., Inc.).

Transfer molding method may be applied in order to seal the semiconductor chips CP and the frame 20. In this case, the semiconductor chips CP and the frame 20 attached to the adhesive sheet 10 are housed, for instance, inside a die of a sealer. An inside of the die is filled with a fluid resin material and then the resin material is cured. Heating and pressure conditions in the transfer molding are not particularly limited. As one example of usual conditions of the transfer molding, a temperature of 150 degrees C. and a pressure ranging from 4 MPa to 15 MPa are maintained for duration ranging from 30 seconds to 300 seconds. Subsequently, after being depressurized, a cured substance is taken out from the sealer and left still at 150 degrees C. for duration ranging from two hours to 15 hours. The semiconductor chips CP and the frame 20 are thus sealed.

When the sheet-shaped sealing resin 30 is used in the above sealing step, a first heat press step may be performed before the step of thermally curing the sealing resin 30 (thermal cure step). In the first heat press step, the adhesive sheet 10, and the semiconductor chips CP and the frame 20 covered with the sealing resin 30 and attached to the adhesive sheet 10 are interposed between plate members and pressed under conditions of predetermined temperature, time and pressure. By performing the first heat press step, the sealing resin 30 is easily fed into the interval between the semiconductor chips CP and the frame 20. Moreover, by performing the heat press step, unevenness of the sealing resin layer 30A formed of the sealing resin 30 can be flattened. As the plate member, for instance, a metallic plate such as a stainless steel is usable.

When the adhesive sheet 10 is peeled after the thermal cure step, the semiconductor chips CP and the frame 20 sealed with the sealing resin 30 are obtained. Hereinafter, the semiconductor chips CP and the frame 20 sealed with the sealing resin 30 are sometimes referred to as a sealing body 50.

### Reinforcing-Member-Attaching Step

FIG. 2D is a schematic illustration for describing the step of attaching the reinforcing member 40 to the sealing body 50.

After peeling the adhesive sheet 10, the exposed circuit surfaces of the semiconductor chips CP are subjected to a rewiring step and a solder-bumping step. In order to improve handleability of the sealing body 50 in the rewiring step and the solder-bumping step, the reinforcing member 40 may be attached to the sealing body 50 as needed (a reinforcing-member-attaching step). The reinforcing-member-attaching step, if performed, is preferably performed before the adhesive sheet 10 is peeled. As shown in FIG. 2D, the sealing body 50 is supported while being interposed between the adhesive sheet 10 and the reinforcing member 40.

In the exemplary embodiment, the reinforcing member 40 includes a heat-resistant reinforcing plate 41 and a heat-resistant bonding layer 42. The reinforcing plate 41 is exemplified by a plate member containing a heat-resistant resin such as a glass epoxy resin. The bonding layer 42 bonds the reinforcing plate 41 to the sealing body 50. The bonding layer 42 is appropriately selected depending on materials of the reinforcing plate 41 and the sealing resin layer 30A.

In the reinforcing-member-attaching step, it is preferable to perform a second heating press step including: interposing the bonding layer 42 between the sealing resin layer 30A of the sealing body 50 and the reinforcing plate 41; further placing plate members respectively to the reinforcing plate 41 and the adhesive sheet 10; and pressing with the plate members under conditions of predetermined temperature, time and pressure. The sealing body 50 and the reinforcing member 40 are temporarily fixed to each other by the second heating press step. After the second heating press step, the temporarily fixed sealing body 50 and reinforcing member 40 are preferably heated under conditions of predetermined temperature and time in order to cure the bonding layer 42. Thermal curing conditions, which are appropriately set depending on a material for the bonding layer 42, are, for instance, 185 degrees C., 80 minutes, and 2.4 MPa. Also in the second heating press step, the plate members are exemplified by a metallic plate such as a stainless steel.

### Peeling Step

FIG. 2E is a schematic illustration for describing the step of peeling the adhesive sheet 10.

In the exemplary embodiment, when the base material 11 of the adhesive sheet 10 is flexible, the adhesive sheet 10 is easily peelable from the frame 20, the semiconductor chips CP and the sealing resin layer 30A while being flexed. Although a release angle θ is not particularly limited, the release angle θ for peeling the adhesive sheet 10 is preferably 90 degrees or more. At the release angle θ of 90 degrees or more, the adhesive sheet 10 is easily peelable from the frame 20, the semiconductor chips CP and the sealing resin layer 30A. The release angle θ is preferably in a range from 90 degrees to 180 degrees, preferably in a range from 135 degrees to 180 degrees. Since the adhesive sheet 10 is peeled while being flexed, loads applied on the frame 20, the semiconductor chips CP and the sealing resin layer 30A during the peeling are reducible, so that the semiconductor chips CP and the sealing resin layer 30A are inhibited from being damaged due to the peeling of the adhesive sheet 10. After peeling the adhesive sheet 10, the above-mentioned rewiring step, solder-bumping step and the like are performed. After peeling the adhesive sheet 10 and before performing the above-mentioned rewiring step, solder-bumping step and the like, the above-described reinforcing-member-attaching step may be performed.

The reinforcing member 40, if attached, is peeled off from the sealing body 50 at a timing when it is no more necessary to support the sealing body 50 using the reinforcing member 40 after the rewiring step, the solder-bumping step and the like are performed.

Subsequently, the sealing body 50 is cut into pieces per each of the semiconductor chips CP (a singulation step). A method of cutting the sealing body 50 into pieces is not particularly limited. For instance, the same method as the method used for dicing the semiconductor wafer is usable for cutting the sealing body 50 into pieces. The sealing body 50 attached to a dicing sheet or the like may be subjected to the singulation step of the sealing body 50. Since the sealing body 50 is cut into pieces, a semiconductor package is manufactured per each of semiconductor chips CP. The semiconductor package is installed on a printed wiring board and the like in an installment step.

The exemplary embodiment provides the adhesive composition easily peelable from the adherend and leaving less adhesive residue on the adherend. Further, the exemplary embodiment provides the adhesive sheet 10 having the adhesive layer 12 containing the adhesive composition.

The adherend in contact with the adhesive layer 12 is, for instance, the semiconductor chips CP and the frame 20. The adhesive layer 12 is subjected to a high temperature while being in contact with the semiconductor chips CP and the frame 20. As compared with a typical adhesive sheet used in a high temperature process, the adhesive sheet 10 is easily peelable and leaves less adhesive residue on the semiconductor chips CP and the frame 20 even after the adhesive sheet 10 is subjected to a high temperature.

### Modifications of Embodiment(s)

The scope of the invention is not limited to the above-described exemplary embodiment(s) but includes modifications and improvements compatible with the invention. It should be noted that the same reference signs are attached to the same members and the like as those of the above exemplary embodiment(s) and explanation thereof is omitted or simplified hereinbelow.

In the exemplary embodiment, it is described as an example that the adhesive layer 12 of the adhesive sheet 10 is covered with the release sheet RL. However, the invention is not limited to the above exemplary embodiment.

The adhesive sheet 10 may be in a form of a sheet. A plurality of the adhesive sheets 10 may be laminated. In this arrangement, for instance, the adhesive layer 12 of one of adhesive sheets 10 may be covered with the base material 11 of another one of the adhesive sheets 10.

Alternatively, the adhesive sheet 10 may be in a form of an elongated sheet and provided in a form of a roll provided by winding the elongated sheet. The adhesive sheet 10 wound in a roll is usable after being unwound from the roll and cut into a desired size.

In the above exemplary embodiment, it is described as an example that the material of the sealing resin 30 is a thermosetting resin. However, the invention is not limited to the above exemplary embodiment. For instance, the sealing resin 30 may be an energy-beam-curable resin that is curable by an energy beam such as an ultraviolet ray.

In the above exemplary embodiment, it is described as an example that the manufacturing method of the semiconductor device includes attaching the frame 20 to the adhesive sheet 10. However, the invention is not limited to the above exemplary embodiment. The adhesive sheet 10 may be used in a manufacturing method of a semiconductor device configured to seal a semiconductor element without using a frame.

### EXAMPLE(S)

The invention will be described in further detail with reference to Example(s). The invention is, however, by no means limited by Example(s).

### Evaluation Method

The adhesive sheet was evaluated in accordance with methods described below.

### Evaluation of Adhesive Force

A 25-mm wide cut adhesive sheet was laminated on each of a copper foil and a polyimide film (adherends) at the room temperature to provide a sheet provided with the copper foil (hereinafter also referred to as a copper foil sheet) and a sheet provided with the polyimide film (hereinafter also referred to as a polyimide film sheet). As the copper foil, a stretched copper foil having a 0.08-mm thickness in accordance with a C1220R-H standard was used. As the polyimide film, a 25-μm thick Kapton 100H (product name) manufactured by DUPONT-TORAY CO., LTD was used.

The copper foil sheet and the polyimide film sheet were heated at 100 degrees C. for 30 minutes, subsequently heated at 180 degrees C. for 30 minutes, and further heated at 190 degrees C. for one hour. After heating the copper foil sheet and the polyimide film sheet, an adhesive force for peeling the adhesive sheet from each of the copper foil and the polyimide film at a release angle of 180 degrees at a release speed of 300 mm/min at the room temperature was measured. The thus measured adhesive force in a range from 0.7 N/25 mm to 2.0 N/25 mm was determined as “A.” The adhesive force less than 0.7 N/25 mm or more than 2.0 N/25 mm was determined as “B.” As a measurement machine of the adhesive force, TENSILON (product name) manufactured by ORIENTEC Co., Ltd. was used.

### Evaluation of Adhesive Residue

The copper foil sheet and the polyimide film sheet used in the above adhesive force evaluation were heated at 200 degrees C. for one hour. After heating the copper foil sheet and the polyimide film sheet, the adhesive sheet was peeled off from each of the copper foil and the polyimide film at a release angle of 180 degrees at a release speed of 3 mm/min at the room temperature. A surface of the copper foil and a surface of the polyimide film after the adhesive sheet was peeled off therefrom were visually observed and checked whether the residue was present or not on the surface of each of the adherends. When no adhesive residue was left on the surface of the adherend after the adhesive sheet was peeled, the adhesive residue was evaluated as “A.” When a trace of the attached adhesive sheet was observed, the adhesive residue was evaluated as “B.”

### Production of Adhesive Sheet

### Example 1

### Preparation of Adhesive Composition

The following materials (i.e., a polymer, an adhesive aid, a cross-linker, a diluting solvent) were blended and sufficiently stirred to prepare a coating adhesive solution (adhesive composition) used in Example 1.

Polymer: acrylic acid ester copolymer of 40 parts by mass (a solid component)

The acrylic acid ester copolymer was prepared by copolymerizing 2-ethylhexyl acrylate of 92.8 mass %, 2-hydroxyethyl acrylate of 7.0 mass %, and acrylic acid of 0.2 mass %.

Adhesive Aid: hydrogenated polybutadiene having hydroxyl groups at both ends: GI-1000 manufactured by NIPPON SODA CO., LTD., 5 parts by mass (a solid component)

Cross-linker: aliphatic isocyanate having hexamethylene diisocyanate (an isocyanurate modified substance of hexamethylene diisocyanate) (CORONATE HX manufactured by Nippon Polyurethane Industry Co., Ltd.), 3.5 parts by mass (a solid component)

Diluting Solvent: methyl ethyl ketone was used to prepare the coating adhesive solution so that a concentration of the solid component was 30 mass %.

### (2) Preparation of Adhesive Layer

The prepared coating adhesive solution was coated using a comma coater (registered trade mark) on a silicone release layer of a release film (SP-PET382150 manufactured by Lintec Corporation) that is a 38-μm thick transparent polyethylene terephthalate film so that a thickness of the adhesive layer became 50 μm after the adhesive layer was dried. Subsequently, the coated film was heated at 90 degrees C. for 90 seconds and at 115 degrees C. for 90 seconds to be dried, thereby preparing the adhesive layer.

### (3) Manufacturing of Adhesive Sheet

After drying the film coated with the coating adhesive solution, the obtained adhesive layer and the base material were attached to each other to provide the adhesive sheet of Example 1. A transparent polyethylene terephthalate film (PET50A-4300 manufactured by TOYOBO CO., LTD., 50-μm thickness) was used as the base material. The adhesive layer was attached to an easily bonding surface of the base material.

### Example 2

An adhesive sheet of Example 2 was produced in the same manner as in Example 1 except that the adhesive aid contained in the adhesive layer was different from that in Example 1.

The adhesive aid used in Example 2 was hydrogenated polybutadiene having hydroxyl groups at both ends (GI-3000 manufactured by NIPPON SODA CO., LTD).

### Comparative 1

An adhesive sheet of Comparative 1 was produced in the same manner as in Example 1 except that the adhesive layer did not contain the adhesive aid.

### Comparative 2

An adhesive sheet of Comparative 2 was produced in the same manner as in Example 1 except that the adhesive aid contained in the adhesive layer was different from that in Example 1.

The adhesive aid used in Comparative 2 was acetyl tributyl citrate (manufactured by Taoka chemical Co., Ltd.). It should be noted that acetyl tributyl citrate does not have the above-described reactive group.

Table 1 shows compositions of the coating adhesive solutions used in Examples 1 and 2 and Comparatives 1 and 2.

TABLE 1

| | | | Composition of Coating | | | |
|---|---|---|---|---|---|---|
| | | | Adhesive Solution | | | |
| | | | (parts by mass) | | | |
| | | | | Adhesive | Cross- | |
| | Polymer Composition | | Polymer | Aid | linker | |
| | Monomer and | Adhesive | (solid | (solid | (solid | Diluting |
| | Monomer mass ratio | Aid | content) | content) | content) | Solvent |
| Example 1 | 2EHA/HEA/AAc | GI-1000 | 40 | 5 | 3.5 | 20 |
| Example 2 | 92.8/7/0.2 | GI-3000 | 40 | 5 | 3.5 | 20 |
| Comp. 1 | | none | 40 | 0 | 3.5 | 20 |
| Comp. 2 | | ATBC | 40 | 5 | 3.5 | 20 |

HEA: 2-hydroxyethyl acrylate
2EHA: 2-ethylhexyl acrylate
AAc: acrylic acid
ATBC: acetyl tributyl citrate

Table 2 shows evaluation results of the adhesive sheets used in Examples 1 and 2 and Comparatives 1 and 2.

TABLE 2

| | Adherend | | | | | |
|---|---|---|---|---|---|---|
| | Copper Foil | | | Polyimide film | | |
| | Adhesive Force | | | Adhesive Force | | |
| | Evaluation | | Adhesive | Evaluation | | Adhesive |
| | | Adhesive | Residue | | Adhesive | Residue |
| | | Force | Evaluation | | Force | Evaluation |
| | Result | [N/25 mm] | Result | Result | [N/25 mm] | Result |
| Example 1 | A | 1.2 | A | A | 1.1 | A |
| Example 2 | A | 1.2 | A | A | 1.1 | A |
| Comp. 1 | A | 0.9 | B | A | 1.2 | B |
| Comp. 2 | B | 0.4 | B | B | 0.6 | B |

The adhesive layer of each of Examples 1 and 2 contained the adhesive composition including: the acrylic copolymer containing 2-ethylhexyl acrylate as the main monomer; and the adhesive aid containing the reactive group-containing rubber material as the main component. The adhesive sheets of Examples 1 and 2 reduced the adhesive residue left on the adherend. An adhesive residue was observed on the adhesive sheets of Comparatives 1 and 2.

The adhesive sheets of Examples 1 and 2 after being heated exhibited a reduced adhesive force. The adhesive sheet of Comparative 2 exhibited an excessively reduced adhesive force after being heated. In view of this, in each of the heated adhesive sheets of Examples 1 and 2, the adhesive force was reduced not excessively but appropriately.

Accordingly, the adhesive composition of the invention and the adhesive sheet using the adhesive composition are suitably usable in a semiconductor device manufacturing process including a step performed under a high temperature.

### EXPLANATION OF CODE(S)

10 . . . adhesive sheet, 11 . . . base material, 12 . . . adhesive layer, 20 . . . frame, 21 . . . opening.

1. An adhesive composition comprising:
an acrylic copolymer; and
an adhesive aid, wherein
the acrylic copolymer comprises 2-ethylhexyl acrylate as a main monomer, and
the adhesive aid comprises a rubber material having a reactive group, as a main component.

2. The adhesive composition according to claim 1, wherein the reactive group is a hydroxyl group.

3. The adhesive composition according to claim 1, wherein the rubber material is a polybutadiene material.

4. The adhesive composition according to claim 1, wherein
the rubber material is a hydrogenated polybutadiene material.

5. The adhesive composition according to claim 1, wherein
the adhesive composition comprises: a cross-linked substance obtained by cross-linking a composition at least comprising the acrylic copolymer, the adhesive aid, and a cross-linker comprising a compound having an isocyanate group as a main component.

6. The adhesive composition according to claim 1, wherein
a ratio of a copolymer component derived from 2-ethylhexyl acrylate in the acrylic copolymer is in a range from 50 mass % to 95 mass %.

7. The adhesive composition according to claim 1, wherein
the acrylic copolymer further comprises a copolymer component derived from an acrylic acid, and
a ratio of the copolymer component derived from the acrylic acid in the acrylic copolymer is 1 mass % or less.

8. An adhesive sheet comprising:
a base material; and
an adhesive layer comprising the adhesive composition according to claim 1.

9. The adhesive sheet according to claim 8, wherein
the adhesive layer has an adhesive force to a copper foil and a polyimide film in a range from 0.7 N/25 mm to 2.0 N/25 mm at a room temperature, after the adhesive sheet is heated at 100 degrees C. for 30 minutes, subsequently at 180 degrees C. for 30 minutes, and further at 190 degrees C. for one hour.

10. The adhesive sheet according to claim 8, wherein the adhesive sheet has a thickness in a range from 5 μm to 60 μm.

11. The adhesive composition according to claim 1, wherein
when the acrylic copolymer further comprises a copolymer component derived from an acrylic acid, a ratio of the copolymer component derived from the acrylic acid in the acrylic copolymer is 1 mass % or less.

12. The adhesive composition according to claim 11, wherein
the ratio of the copolymer component derived from the acrylic acid in the acrylic copolymer ranges from 0.1 mass % to 0.5 mass %.

13. The adhesive composition according to claim 1, wherein
a ratio of a copolymer component derived from 2-ethylhexyl acrylate in the acrylic copolymer is in a range from 80 mass % to 95 mass %.
